(19) United States
(12) Patent Application Publication
(10) Pub. No.: US 2024/0240117 A1
(43) Pub. Date: Jul. 18, 2024

(54) CLEANING WET WIPE

(71) Applicant: DAIO PAPER CORPORATION, Shikokuchuo-shi, Ehime (JP)

(72) Inventor: Ryota HONJO, Shikokuchuo-shi (JP)

(73) Assignee: DAIO PAPER CORPORATION, Shikokuchuo-shi, Ehime (JP)

(21) Appl. No.: 18/558,771

(22) PCT Filed: Mar. 8, 2022
(86) PCT No.: PCT/JP2022/009869

§ 371 Date: Nov. 3, 2023

(30) Foreign Application Priority Data
May 24, 2021 (JP) 2021-087128

(51) Int. Cl. C11D 17/04; A47L 13/17; A47L 13/254; C11D 1/72; C11D 3/43

(52) U.S. Cl. CPC C11D 17/049; A47L 13/17; A47L 13/254; C11D 1/72; C11D 3/43

(57) ABSTRACT

A cleaning wet wipe that is obtained by impregnating a base paper sheet with a chemical agent. The chemical agent has a hydrogen ion exponent of 8.0 to 9.0 and contains 0.05% by mass to 0.15% by mass of polyoxyethylene alkyl ether and 5.00% by mass to 15.00% by mass of ethanol.

### TECHNICAL FIELD

The present invention relates to a cleaning wet wipe.

### BACKGROUND

When cleaning floor surfaces, kitchen areas, and the like, it is convenient to use special sheets that can be used and discarded. Therefore, inventions of cleaning sheets used for cleaning various surfaces to be cleaned are known (see, for example, Patent Document 1).

### CITATION LIST

Patent Document 1: JP 2019-216843 A

### SUMMARY

In such a cleaning sheet, it is important to improve wiping performance against dirt on the surface to be cleaned. Therefore, conventionally, for example, a special chemical agent has been impregnated into the sheet to improve its wiping performance against dirt. However, oil stains (stains that have dried and adhered after oil has adhered) and liquid stains (stains that have dried and adhered after liquid has adhered), which are often found around the kitchen and other areas, are often difficult to remove. Therefore, further improvement of wiping performance for these stains has been demanded.

An object of the present invention is to improve wiping performance against oil stains and liquid stains of a cleaning wet wipe.

In order to solve the above problems, a cleaning wet wipe is disclosed that is obtained by impregnating a base paper sheet with a chemical agent, wherein
the chemical agent has a hydrogen ion exponent of 8.0 to 9.0 and contains 0.05% by mass to 0.15% by mass of polyoxyethylene alkyl ether and 5.00% by mass to 15.00% by mass of ethanol.

The chemical agent contains 8.00% by mass to 12.00% by mass of ethanol.

Embossment blocks in each of which a plurality of convex embossments that are embossments having convexity in a first surface of the cleaning wet wipe are gathered, wherein the embossment blocks which are a plurality of embossment blocks are continuously arranged and form embossment block rows from a first side to a second side opposite to the first side; and
a non-embossment part where the embossments are not arranged, between other ones of the embossment blocks which are adjacent, wherein
the embossment block rows which are a plurality of embossment block rows are continuously arranged from a third side perpendicularly intersecting the first side to a fourth side opposite to the third side,
the non-embossment part is provided at a proportion of not less than 25% and not more than 50% with respect to an area of the cleaning wet wipe, and
the convex embossments are arranged such that at least one of the convex embossments is present on a straight line extended perpendicularly from an arbitrary point on the third side to the fourth side.

The cleaning wet includes concave embossments that are embossments having convexity in a second surface of the cleaning wet wipe, wherein
the embossment blocks are combinations of the plurality of convex embossments and the concave embossments, and
the concave embossments are arranged such that at least one of the concave embossments is present on a line extended from an arbitrary point on the third side to the fourth side.

An angle formed between a long axis direction of the embossments and a first direction that perpendicularly intersects the first side is not less than 5º and not more than 45°, and
the embossment blocks have diamond shapes.

The embossments have oval shapes and have narrowed parts at substantially centers thereof in a long axis direction.

According to the present invention, it is possible to improve wiping performance against oil stains and liquid stains of a cleaning wet wipe.

### BRIEF DESCRIPTION OF DRAWINGS

FIG. 1 This is a perspective view of a cleaning tool with a cleaning wet wipe attached thereto according to an embodiment of the present invention.

FIG. 2 This is a plan view illustrating the cleaning wet wipe according to the embodiment of the present invention.

FIG. 3 This is a plan view illustrating a cleaning wet wipe according to a modification example.

FIG. 4A This is a plan view illustrating an embossment pattern according to an example.

FIG. 4B This is a plan view illustrating an embossment pattern according to an example.

FIG. 4C This is a plan view illustrating an embossment pattern according to a comparative example.

FIG. 4D This is a plan view illustrating an embossment pattern according to a comparative example.

### DETAILED DESCRIPTION

Hereinafter, a cleaning wet wipe 100 that is an embodiment of the present invention will be described with reference to the drawings. However, the technical scope of the present invention is not limited to the illustrated examples and is determined on the basis of the description of the claims.

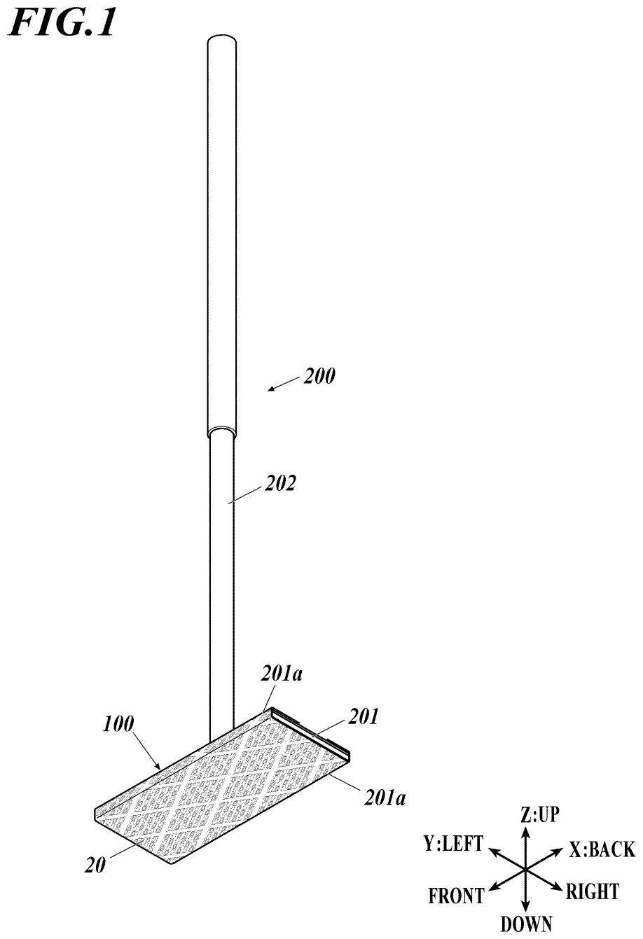

Note that the following description will be given by defining front, back, left, right, up, down, an X direction, a Y direction, and a Z direction as illustrated in FIG. 1. Also, “to” is used as having a meaning including numerical values described before and after it as a lower limit value and an upper limit value in this specification.

### 1 Description of Configuration

First, the configuration of a cleaning wet wipe 100 will be described.

### [(1) State When Used]

As illustrated in FIG. 1, the cleaning wet wipe 100 is, for example, a sheet obtained by impregnating a base paper sheet with a chemical agent, and is used for floor cleaning by being exchangeably attached to a cleaning tool 200 including a head 201 with a rectangular flat plate shape and a handle 202 attached to an upper surface of the head 201. Here, the base paper sheet refers to the state of the cleaning wet wipe 100 before it is impregnated with the chemical agent.

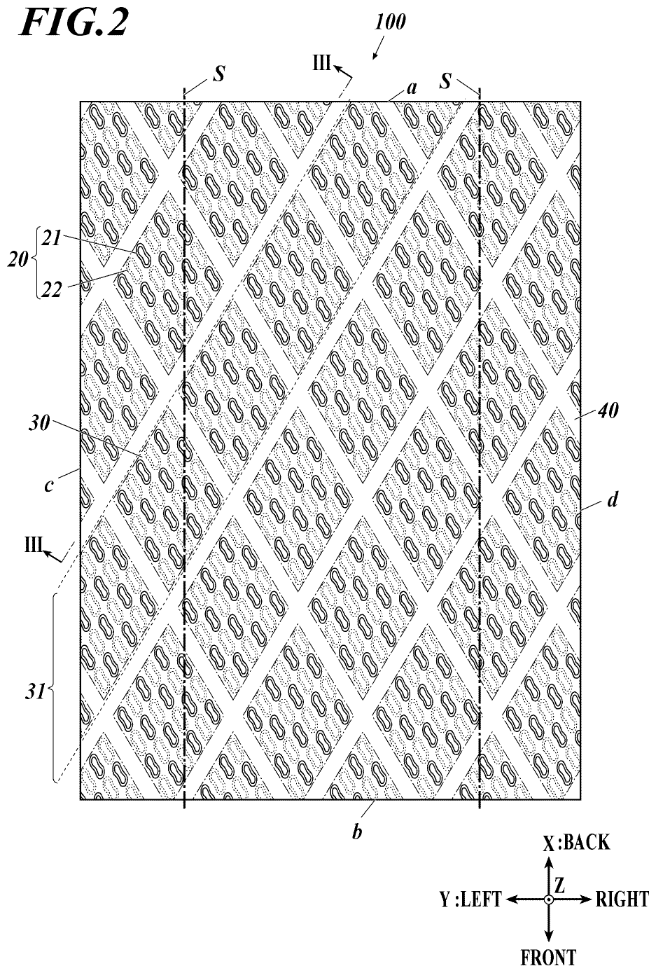

The cleaning wet wipe 100 is formed in an rectangular shape as illustrated in FIG. 2, covers a bottom surface of the head 201 of the cleaning tool 200 to form a cleaning surface, is bent at fold lines S along longitudinal edges 201a of the head 201 of the cleaning tool 200, is locked at the upper surface of the head 201, and is thereby brought into a state being attached to the cleaning tool 200.

Note that the longitudinal edges 201a indicate edges of the head 201 in the longitudinal direction. In other words, the longitudinal edges 201a indicate two longer edges from among the four edges of the rectangular head 201.

### [(2) Base Paper Sheet]

The base paper sheet is a nonwoven fabric manufactured by joining predetermined fibers by a known technology such as spun lace, air-through, air-laid, point bond, spun bond, or needle punch.

Specifically, the base paper sheet is, for example, a nonwoven fabric manufactured by mixing hydrophilic and hydrophobic fibers and then joining these fibers.

### [a Hydrophilic Fibers]

As the hydrophilic fibers, it is possible to use natural fibers such as cotton, pulp, or hemp, regenerated fibers such as rayon or cupra, or the like. It is preferable to use pulp, rayon, polypropylene spun bond fibers (PPSB), or the like from the viewpoint of maintaining water retention properties.

The blending proportion of hydrophilic fibers in the fibers constituting the base paper sheet is preferably 40% by mass to 80% by mass.

### [b Hydrophobic Fibers]

Examples of the hydrophobic fibers include polyolefin-based fibers such as polyethylene (PE), polypropylene (PP), or polyvinyl alcohol, polyester-based fibers such as polyethylene terephthalate (PET) or polybutylene terephthalate (PBT), acrylic-based fibers, and the like. These can be used alone, or two types or more of them can be used in combination. Examples of composite fibers of two or more types include a core-sheath type including a resin with a relatively low melting point (low-melting point resin) as a sheath and a resin with a relatively high melting point (high-melting point resin) as a core, a side-back type including a low-melting point resin and a high-melting point resin aligned in a predetermined direction, and the like.

The blending proportion of hydrophobic fibers in the fibers constituting the base paper sheet is preferably 20% by mass to 60% by mass.

### [c Basis Weight]

The basis weight of the base paper sheet is preferably 50 g/m² to 100 g/m² from the viewpoint of both dirt retention capacity and sheet flexibility. The basis weight is the basis weight measured in accordance with JIS P8124:2011 (the same applies hereinafter).

### [d CNF]

It is possible to add cellulose nanofibers (CNFs) to the base paper sheet.

CNFs refer to fine cellulose fibers that are obtained by defibrating pulp fibers, and typically refer to cellulose fibers including cellulose fine fibers that have a nano-size (1 nm to 1000 nm) fiber width, and fibers with an average fiber width of not more than 100 nm are preferably used. For calculation of the average fiber width, a number average of a certain number, a median, or a mode diameter (most frequent value), for example, is used.

The CNFs may be in a state where they are uniformly impregnated in the thickness direction of the base paper sheet, and the CNFs are preferably in a state where the content of CNFs gradually increases from the center of the base paper sheet in the thickness direction toward the front surface and the rear surface. This is because the cleaning wet wipe 100 thus becomes unlikely to tear even when the cleaning surface or the like is strongly rubbed.

[(a) Pulp Fiber that can be Used for CNFs]

Examples of pulp fibers that can be used for manufacturing the CNFs include chemical pulp such as hardwood pulp (LBKP) and softwood pulp (NBKP), machine pulp such as bleached thermomechanical pulp (BTMP), stone ground pulp (SGP), pressurized stone ground pulp (PGW), refiner ground pulp (RGP), chemiground pulp (CGP), thermoground pulp (TGP), ground pulp (GP), thermomechanical pulp (TMP), chemi-thermomechanical pulp (CTMP), and refiner mechanical pulp (RMP), waste paper pulp manufactured from used tea paper, used craft envelope paper, used magazine paper, used newspaper, used flyer paper, used office paper, used cardboard paper, used white paper, used Kent paper, used art paper, used ticket paper, used woody paper, and the like, deinked pulp (DIP) obtained by performing a deink treatment on used paper pulp, and the like. These may be used alone, or a plurality of types thereof may be used in combination, as long as the advantages of the present invention are not impaired.

### [(b) Method for Defibrating CNFs]

Although it is possible to exemplify mechanical methods such as a high-pressure homogenizer method, a micro-fluidizer method, a grinder grinding method, a bead mill freezing crushing method, and an ultrasonic defibrating method, the defibrating method used in manufacturing the CNFs is not limited thereto.

Note that since the CNFs after being subjected only to the mechanical treatment by the above defibrating method or the like (not modified), that is, the CNFs not modified with a functional group have higher heat stability than those modified with a functional group such as a phosphate group or a carboxymethyl group, such CNFs can be used for a wider range of applications, but it is also possible to use the CNFs modified with a functional group such as a phosphate group or a carboxymethyl group in the present invention.

Also, a chemical treatment such as carboxymethylation may be performed on the pulp fibers after being subjected to a defibrating treatment based on a mechanical method, for example, or an enzyme treatment may be performed thereon. Examples of the CNF after being subjected to a chemical treatment include individualized CNFs (iCNFs) (single nano cellulose) with a diameter of 3 nm to 4 nm, such as TEMPO-oxidized CNFs, phosphorylated CNFs, and phosphite-esterified CNFs, for example.

Additionally, CNFs after being subjected only to a chemical treatment or an enzyme treatment or CNFs obtained by performing a defibrating treatment based on a mechanical method on the CNFs after being subjected to a chemical treatment or an enzyme treatment may be used.

### [(3) Chemical Agent]

The chemical agent used to impregnate the base paper sheet as described above is slightly alkaline with a hydrogen ion exponent (pH) of 8.0 to 9.0, containing 0.05% by mass to 0.15% by mass of polyoxyethylene alkyl ether (AE), and 5.00% by mass to 15.00% by mass, preferably 8.00% by mass to 12.00% by mass, of ethanol.

The chemical agent to be impregnated is 150% by mass to 450% by mass of the mass of the base paper sheet when dry, preferably 180% by mass to 350% by mass.

The chemical agent is impregnated into the dried base paper sheet and is discharged from the cleaning surface when the cleaning wet wipe 100 is used.

### [(4) Embossment]

In order to create unevenness on the wipe and improve the wiping performance against dirt on the surface to be cleaned by scraping off the dirt by the unevenness, embossments 20 that are parts where the wipe is compressed in the Z direction are arranged in the cleaning wet wipe 100 as illustrated in FIGS. 1 and 2.

The embossments 20 are formed into so-called gourd shapes that have thin and long oval shapes with shorter lengths and narrow widths in one direction and have narrowed parts substantially at centers thereof in the long axis direction in plan view, as illustrated in FIG. 2, for example. The shapes of the embossments 20 are not limited thereto, and various shapes such as polygonal shapes and shapes as combinations of shapes, for example, may be used. However, such gourd shapes are preferable from the viewpoint of improving dirt scraping properties.

Such embossments 20 can be formed through heat embossing under conditions of a temperature of 80° C. to 200° C. and an embossing pressure of 0.2 MPa to 1.0 MPa, for example. In a case where the embossments 20 are formed through heat embossing, it is possible to use a convex embossment roll having at least an outer circumferential surface made of carbon steel, stainless steel, a cured resin such as polypropylene or an acrylonitrile butadiene styrene (ABS) resin, or the like. Among these, it is preferable to use the convex embossment roll made of stainless steel from the viewpoint of durability and heat resistance.

Also, in the case where embossment working is performed through heat embossing, it is preferable to perform it before the process of impregnating the cleaning wet wipe 100 with the chemical agent from the viewpoint of easiness in application of the convex and concave shapes.

### [a Convex Embossment and Concave Embossment]

As the embossment 20, convex embossments 21 that have convex shapes on the upper side in the Z direction (the first surface side of the cleaning wet wipe 100) and concave embossments 22 that have convex shapes on the lower side (the second surface side of the cleaning wet wipe 100) (that is, that have concave shapes on the upper side in the Z direction) are formed. Note that the convex embossments 21 are illustrated by solid lines while the concave embossments 22 are illustrated by dashed lines in each drawing.

The convex embossments 21 are formed to have lengths of 5 mm to 10 mm, preferably of 6 mm to 8 mm in the long axis direction, lengths of 2 mm to 5 mm, preferably of 3 mm to 4 mm in the short axis direction that perpendicularly intersects the long axis direction, and lengths (the heights from the intermediate part (which will be described later)) of 0.5 mm to 2 mm, preferably of 0.7 mm to 1.5 mm in the Z direction. The concave embossments 22 are formed upside down into substantially the same shapes as the convex embossments 21 and are formed into convexities toward the lower side in the z direction, in a sectional view.

### [b Intermediate Part]

An intermediate part is formed between the embossments 20 formed in the cleaning wet wipe 100. Since the intermediate part is a part where the embossments 20 are not formed, the intermediate part is located to be lower than the convex embossments 21 and higher than the concave embossments 22 in the Z direction.

### [c Embossment Pattern]

In the cleaning wet wipe 100 according to the present embodiment, first embossment blocks 30 with diamond shapes formed from combinations of the convex embossments 21 and the concave embossments 22 in which an angle formed between the first direction (the X direction in FIG. 2) that perpendicularly intersects a first side a and the long axis direction is 5° to 45°, preferably 15º to 35°, form embossment block rows 31 continuously from the first side a to a second side b as illustrated in FIG. 2, for example. Also, the plurality of embossment block rows 31 are continuously arranged from a third side c to a fourth side d. In a first embossment block row 31 and a second embossment block row 31 adjacent to each other, a first embossment block 30 inside the first embossment block row 31 overlaps, in a second direction (the Y direction in FIG. 2) perpendicularly intersecting the first direction, a second embossment block 30 that is adjacent in the second embossment block 31 row. The convex embossments 21 and the concave embossments 22 are arranged such that at least one convex embossment 21 and at least one concave embossment 22 are present on a straight line extended perpendicularly from an arbitrary point on the third side c to the fourth side d.

### [d Non-Embossment Part]

As illustrated in FIG. 2, a non-embossment part 40 that is the part where the cleaning wet wipe 100 is not compressed in the Z direction compared to the part where the embossment 20 is formed and raised fabric is included is provided between adjacent embossment blocks 30.

The non-embossment part 40 can be formed by designing the convex embossment roll for forming the embossments 20 to exclude the shape of the non-embossment part 40 or by slightly compressing it as compared with the part compressed for the embossments 20 to such an extent that the raised fabric remains.

It is possible to obtain the cleaning wet wipe 100 that reduces occurrence of wiping streaks and exhibits excellent wiping-off properties by such a non-embossment part 40 being provided at a proportion of 25% to 50% with respect to the area of the cleaning wet wipe 100. It is most preferable to provide the non-embossment part 40 for 25% with respect to the area of the cleaning wet wipe 100.

In a case where wiping cleaning is performed with the cleaning wet wipe 100 attached to the cleaning tool 200, it is generally moved substantially perpendicularly to the X direction or the Y direction. In a case where the non-embossment part 40 is formed into one straight line as illustrated in FIG. 2, there is a concern that wiping streaks are likely to occur depending on the angle at which the cleaning wet wipe 100 is moved. Thus, it is more desirable that the embossment blocks 30 be arranged such that the non-embossment part 40 is not on one straight line.

### 2 Description of Effects

According to the cleaning wet wipe 100 in the embodiment, the chemical agent to impregnate the base paper sheet is slightly alkaline with a hydrogen ion exponent (pH) of 8.0 to 9.0, containing 0.05% by mass to 0.15% by mass of polyoxyethylene alkyl ether (AE) and 5.00% by mass to 15.00% by mass of ethanol.

This improves the wiping performance against oil and liquid stains by containing polyoxyethylene alkyl ether, a surfactant for oil and liquid stains, as well as a relatively high ethanol content to float oil stains.

In addition, the relatively fast drying and a pH of 9 or lower suppresses the speed of deterioration of the surface to be cleaned, thus improving the wiping performance for oil and liquid stains while also suppressing the possibility of damaging the surface to be cleaned.

According to the cleaning wet wipe 100 in the embodiment, the embossments 20 are arranged as described above to further improve the wiping performance against dirt due to the unevenness of the wipe, and the following effects can be obtained.

That is, in general, the cleaning tool 200 is moved in the first direction (X direction in FIG. 2) or the second direction (Y direction in FIG. 2) when wiping cleaning is performed by attaching the cleaning wet wipe 100 to the cleaning tool 200 having the head 201. However, when the convex embossments are arranged in series to be aligned along such first direction or second direction, parts where wiping is not performed by the convex embossments (so-called “wiping streaks”) may occur on a surface to be cleaned. A user who has recognized the wiping streaks may determine that a chemical agent has run out and started to dry and discard the wipe even though the chemical agent still remains in the wipe, and the user may use unnecessarily many wipes.

With respect to this, in a case where the cleaning wet wipe 100 that has the embossment pattern as described above and has at least one convex embossment 21 present on the straight line extended perpendicularly from the arbitrary point on the third side c to the fourth side d is attached, the convex embossments 21 have overlapping margin when the wiping cleaning is performed at least in the second direction (the Y direction in FIG. 2). It is thus possible to reduce occurrence of wiping streaks.

Additionally, the convex embossments 21 further projecting than the non-embossment part 40 receives a higher pressure when the wiping cleaning is performed with the cleaning wet wipe 100 by providing the non-embossment part 40 at a proportion of 25% to 50% with respect to the area of the cleaning wet wipe 100 between the embossment blocks 30 without providing the embossments 20 over the entire surfaces of the cleaning wet wipe 100. Therefore, chemical agent discharge properties are improved, and it is possible to further reduce occurrence of wiping streaks.

Also, since the convex embossments 21 receive a higher pressure, scraping properties of the convex embossments 21 is improved, and dust is likely to be accumulated at the non-embossment part 40. It is thus possible to enhance dust capturing properties. In addition, regardless of the improvement in scraping properties of the convex embossments 21 and dust capturing properties of the cleaning wet wipe 100, it is possible to suppress an increase in wiping resistance since the non-embossment part 40 is less likely to be grounded on the surface to be cleaned due to the convex embossments 21.

Also, since the embossment blocks 30 have diamond shapes including embossments 20 with angles of 5° to 45°, preferably 15° to 35°, between the first direction and the long axis direction, the embossment blocks 30 are inevitably arranged with deviation with respect to the first direction of the cleaning wet wipe 100 when the plurality of embossment block rows 31 in which the embossment blocks 30 are arranged continuously from the first side a to the second side b are arranged continuously from the third side c to the fourth side d. Also, a margin occurs in the angle at which the cleaning wet wipe 100 is moved when a user carries out wiping cleaning.

Also, since the embossments 20 have oval shapes and have shapes having narrowed parts substantially at the centers thereof in the long axis direction, it is possible to enhance dirt scraping performance.

### 3 Modification Examples

Hereinafter, modification examples of the above embodiment will be described.

### [(1) Adoption of Multilayered Sheets]

In the above, the case in which a single-layer nonwoven fabric formed by mixing hydrophilic and hydrophobic fibers is used as the base paper sheet is described, but instead of this, a multilayered sheet with a hydrophilic fiber layer consisting mainly of hydrophilic fibers and a hydrophobic fiber layer consisting mainly of hydrophobic fibers may be used.

Specifically, for example, there may be three-layer structure having the surface layer on both sides being a hydrophobic fiber layer consisting mainly of hydrophobic fibers and the middle layer being a hydrophilic fiber layer consisting mainly of hydrophilic fibers, and in the border region between fibers of the hydrophobic fiber layer and fibers of the hydrophilic fiber layer, the fibers may be entangled with each other.

In this case, the chemical agent impregnated in the hydrophilic fiber layer is less likely to be discharged to the surface to be cleaned adjacent to the hydrophobic fiber layer, allowing the chemical agent to be selectively discharged to the surface to be cleaned and inhibiting the discharge of chemical agents that are not effective for cleaning.

Additionally, by configuring each of the hydrophobic fibers and the hydrophilic fibers to be entangled, it is possible to further enhance chemical agent holding properties by air held at the entangled parts.

### [(2) Change of Embossment Pattern]

Although the case where the embossment blocks 30 as combinations of the convex embossments 21 and the concave embossments 22 are formed in the cleaning wet wipe 100 have been described above as an example, it is only necessary for the embossment blocks 30 to include at least the convex embossments 21.

However, it is possible to flip over and use the cleaning wet wipe 100 and to further widen the cleaning area by providing the concave embossments 22, which is preferable.

Also, although the embossment blocks 30 with diamond shapes including embossments 20 with angles of 5° to 45°, preferably 15° to 35°, between the first direction and the long axis direction have been described as an example in FIGS. 1 and 2, the shape of the embossment blocks 30 is not limited thereto. For example, embossment blocks 30 including embossments 20 with angles of 0° or 90° between the first direction and the long axis direction may be used.

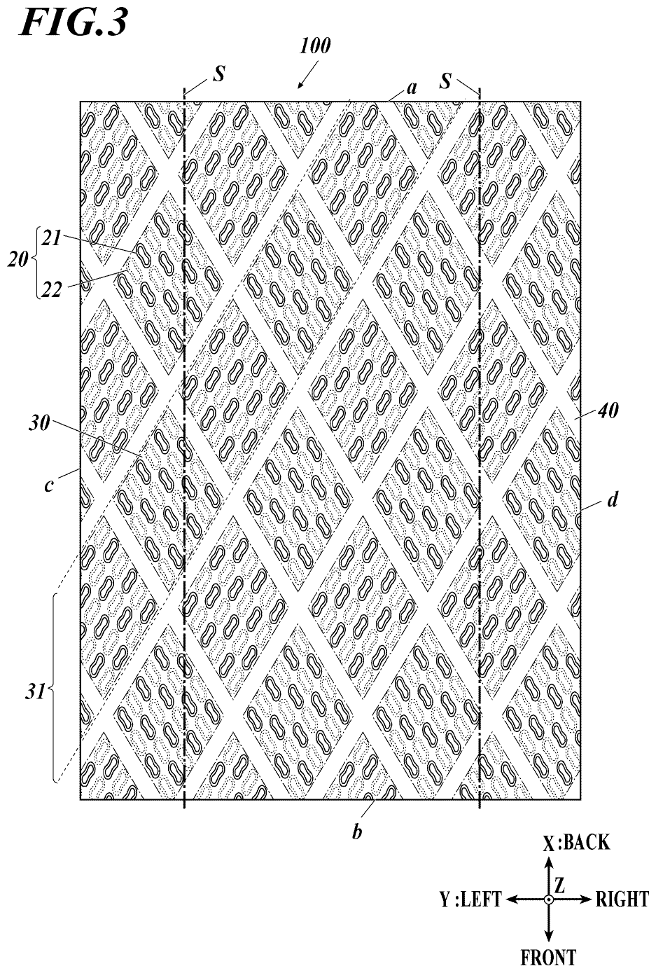

Also, although an example in which both the convex embossments 21 and the concave embossments 22 inside each embossment block 30 have the same angle between the long axis direction and the first direction has been described as an example in FIGS. 1 and 2, the convex embossments 21 and the concave embossments 22 are not limited thereto. As illustrated in FIG. 3, the convex embossments 21 and the concave embossments 22 may be arranged such that the long axis directions of the convex embossments 21 and the concave embossments 22 in the first embossment block 30 are different from the long axis directions of the convex embossments 21 and the concave embossments 22 in the second embossment block 30 that is adjacent to the first embossment block 30.

Also, arrangement in which the angles of the convex embossments 21 and the concave embossments 22 inside the first embossment block 30 are different from each other may be used.

Moreover, although the first side a and the second side b have been defined as shorter sides of the cleaning wet wipe 100 and the third side c and the fourth side d have been defined as longer sides of the cleaning wet wipe 100 in each drawing, the shorter sides and the longer sides are not limited thereto.

Also, although both the convex embossments 21 and the concave embossments 22 have substantially the same gourd shapes in plan view in each drawing, the convex embossments 21 and the concave embossments 22 may have different shapes.

However, the convex embossments 21 and the concave embossments 22 in the cleaning wet wipe 100 are preferably arranged to be substantially symmetrical between the first surface and the second surface in any of the above embossment patterns. In this manner, the first surface and the second surface of the cleaning wet wipe 100 have similar cleaning functions, and it is possible to increase the cleaning area per sheet.

### EXAMPLES

Next, results of evaluating examples and comparative examples of the present invention will be described. Although the present invention will be specifically described below on the basis of the examples, the present invention is not limited thereto.

### [1 Comparison by Composition of Chemical Agent]

First, the results of the evaluation of the difference in wiping performance against dirt due to the composition of the chemical agent to impregnate the base paper sheet are described.

### [(1) Sample Creation]

The following cleaning wet wipes of examples and comparative examples were created.

### a Example 1-1

As the base paper sheet, a nonwoven fabric (rectangular shape, 300 mm on the long side and 200 mm on the short side) with a basis weight of 60 g/m², consisting of 40% by mass PET fiber, 40% by mass rayon fiber, and 20% by mass PP/PE binder, and manufactured by joining them together by spun lace, was used. No embossment working was performed.

The chemical agent used to impregnate the base paper sheet contained 10.00% by mass ethanol and 0.10% by mass polyoxyethylene alkyl ether (AE) (the remaining components were purified water), with a pH of 8.8, and the base paper sheet was impregnated with 200% by mass of the chemical agent with respect to the mass of the base paper sheet when dry.

### b Comparative Example 1-1

The chemical agent described in Patent Document 1 as Example 1 was used as the chemical agent to impregnate the base paper sheet. The other respects were the same as those in Example 1-1.

The specific components of the chemical agent used are as follows.
purified water: 99.434%
benzalkonium chloride 50% aqueous solution: 1.0×10⁻¹%
(benzalkonium chloride: 5.0×10⁻²%)
cetylpyridinium chloride: 3.0×10⁻²%
polyaminopropyl biguanide 20% aqueous solution: 1.0×10⁻¹%
(polyaminopropyl biguanide: 2.0×10⁻²%)
grapefruit seed extract: 1.0×10⁻²%
phenoxyethanol: 3.0×10⁻¹%
citric acid: 5.0×10⁻³%
sodium citrate: 1.0×10⁻³%
aloe extract: 1.0×10⁻²%
glycerin: 1.0×10⁻²%

### [(2) Test Contents]

The following stain removal tests were conducted using the cleaning wet wipes for the above examples and comparative examples.

### [A Creation of Pseudo-Stains]

The following two types of pseudo-stains were applied to the center in the long side direction of a rectangular stainless steel plate of 320 mm on the long side and 180 mm on the short side, to be aligned along the short side direction. In both cases, 0.5 ml was dropped and then allowed to dry for 1 hour at 60°.

### [(a) Pseudo-Stains 1: Cafe Au Lait]

Liquid stains were assumed. Specifically, “Mild Cafe Auree” made by Ezaki Glico Co., Ltd. was used.

### [(b) Pseudo-Stains 1: Curry]

Oil stains were assumed. Specifically, “Curry Craftsman Beef Curry” made by Ezaki Glico Co., Ltd. was used.

### [b Performance of Wiping-Off Test]

Wiping-off tests were performed in the following method.
(i) The sheet of Example 1-1 or Comparative Example 1-1 was placed at the right end of the stainless steel plate (one end in the long side direction of the stainless steel plate, located on the right side as seen by the tester), with the long side of the sheet along the short side direction of the stainless steel plate.
(ii) On top of the sheet, a rubber plate (rectangular shape with 100 mm long side and 100 mm short side, mass 275 g) was placed so that the long side of the rubber plate is in line with the short side of the stainless steel plate.
(iii) The weight was pushed horizontally and moved, along with the sheet, by 200 mm toward the left end of the stainless steel plate (the other end opposite the above-mentioned one end in the long side direction of the stainless steel plate, located on the left side as seen by the tester). The time required for the move was 4 seconds.
(iv) The weight was pushed horizontally and moved, along with the sheet, by 200 mm toward the right end of the stainless steel plate. The time required for the move was 4 seconds.

The above processes (iii) and (iv) were repeated 25 times, and after each iteration, the state of the pseudo-stains on the stainless steel plate was checked. One process of (iii) and (iv) is hereinafter referred to as one wipe.

The same test was performed twice.

### [(3) Test Results]

Results of the test are shown in Table I. For the test results, the number of times each stain was wiped until it was removed (the state of no visible stains) is noted.

TABLE 1

| | TEST RESULTS | | | |
|---|---|---|---|---|
| | CURRY | | CAFE AU LAIT | |
| | TEST 1 | TEST 2 | TEST 1 | TEST 2 |
| EXAMPLE 1-1 | 13 TIMES | 16 TIMES | 2 TIMES | 6 TIMES |
| COMPARATIVE | 25 TIMES | 19 TIMES | 8 TIMES | 8 TIMES |
| EXAMPLE 1-1 | | | | |

### [(4) Evaluation]

Comparing the results of the wiping test using Example 1-1 with the results of the wiping test using Comparative Example 1-1, the number of wipes required until the stain is removed is lower in Example 1-1, in both Test 1 and Test 2 for both curry (oil stain) and cafe au lait (liquid stain).

This indicates that the wiping performance of the cleaning wet wipe against oil and liquid stains can be improved by using a chemical agent that has a hydrogen ion exponent (pH) of 8.0 to 9.0, slightly alkaline, and contains 0.05% by mass to 0.15% by mass polyoxyethylene alkyl ether (AE) and 5.00% by mass to 15.00% by mass ethanol as the chemical agent to impregnate the cleaning wet wipe.

### [2 Comparison by Embossing Configuration]

The results of the evaluation regarding the influence of the pattern of embossing formed on the cleaning wet wipes on the amount of wiping streaks, the amount of wiping and the wiping resistance are then described.

### [(1) Sample Creation]

The following test sheets of examples and comparative examples were created.

### a Example 2-1: Non-Embossment Part 25%

Two hydrophobic fiber layers with a basis weight of 40 g/m² to 50 g/m² and with a proportion of 80% by mass of PET and 20% by mass of PP/PE binder and one hydrophilic fiber layer with a basis weight of 40 g/m² to 50 g/m² and with a proportion of 70% by mass of pulp and 30% by mass of PPSB were created. Then, entangling was caused by a water flow entanglement method such that both surfaces of the hydrophilic fiber layer were sandwiched by the hydrophobic fiber layers, the layers were cut into 300 mm×200 mm, thereby creating one base paper sheet. Then, heat embossing working was performed under conditions of a temperature of 95° C. and an embossing pressure of 0.4 MPa as described below.

That is, as illustrated in FIG. 2, the plurality of embossment block rows 31 in which the plurality of first embossment blocks 30 with diamond shapes that were combinations of the gourd-shaped convex embossments 21 and concave embossments 22 with an angle of 30° between the first direction (the X direction in FIG. 2) and the long axis direction were continuously arranged from the first side a to the second side b opposite to the first side a were continuously arranged from a third side c to a fourth side d. At this time, in the adjacent first embossment block row 31 and second embossment block row 31, the embossments 20 were arranged such that the first embossment blocks 30 in the first embossment block row 31 overlap, in the first direction, the adjacent second embossment blocks 30 in the second embossment block row 31 and at least one convex embossment 21 was present on a line extended perpendicularly from an arbitrary point on the third side c to the fourth side d, and the non-embossment part 40 was provided between the embossment blocks 30 at a proportion of 25.0% with respect to the area of the base paper sheet.

The base paper sheet after heat embossing working were impregnated with 300% by mass of chemical agent containing a water-based detergent, an antiseptic, a disinfectant, and an alcohol, with respect to the mass of the base paper sheet when dry.

### b Example 2-2: Non-Embossment Part 37.5%)

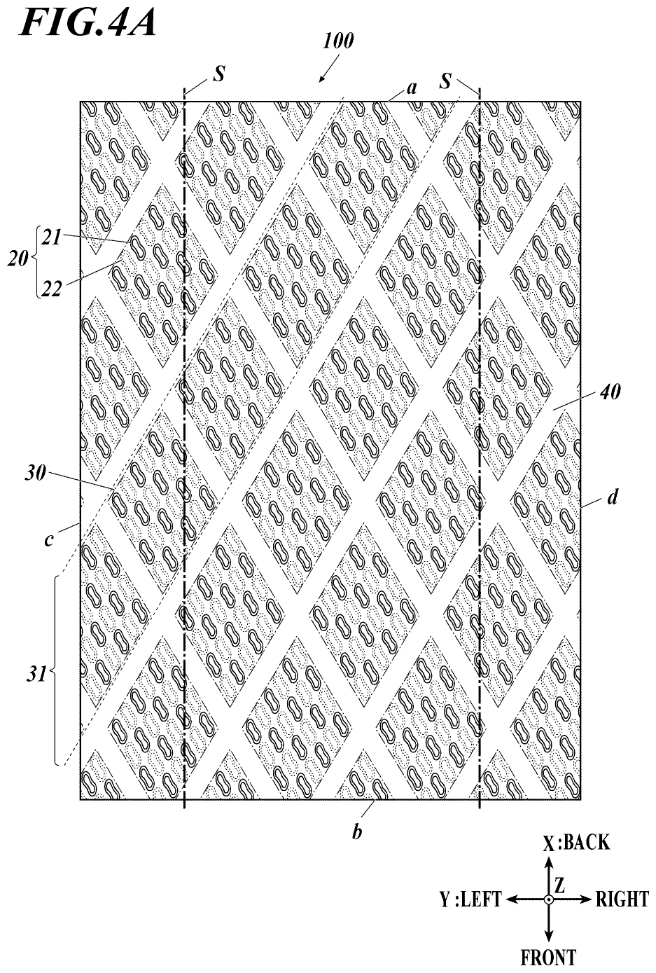

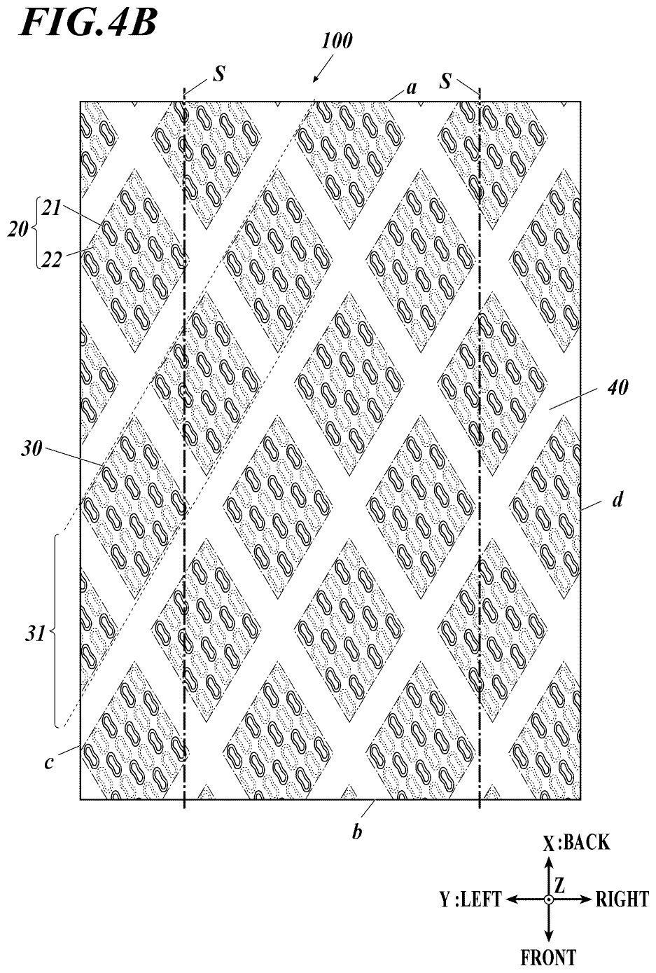

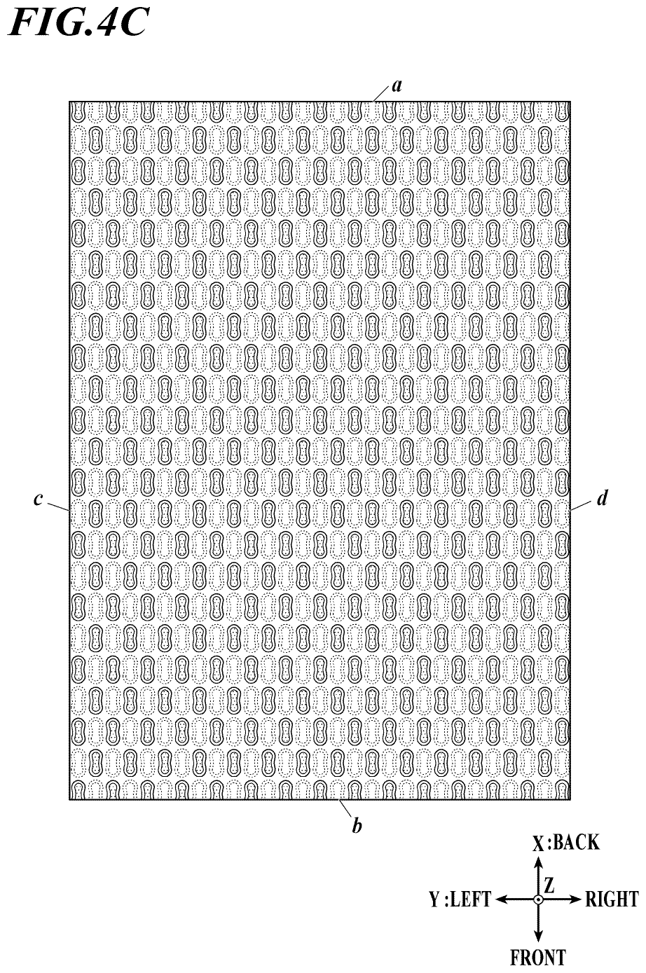

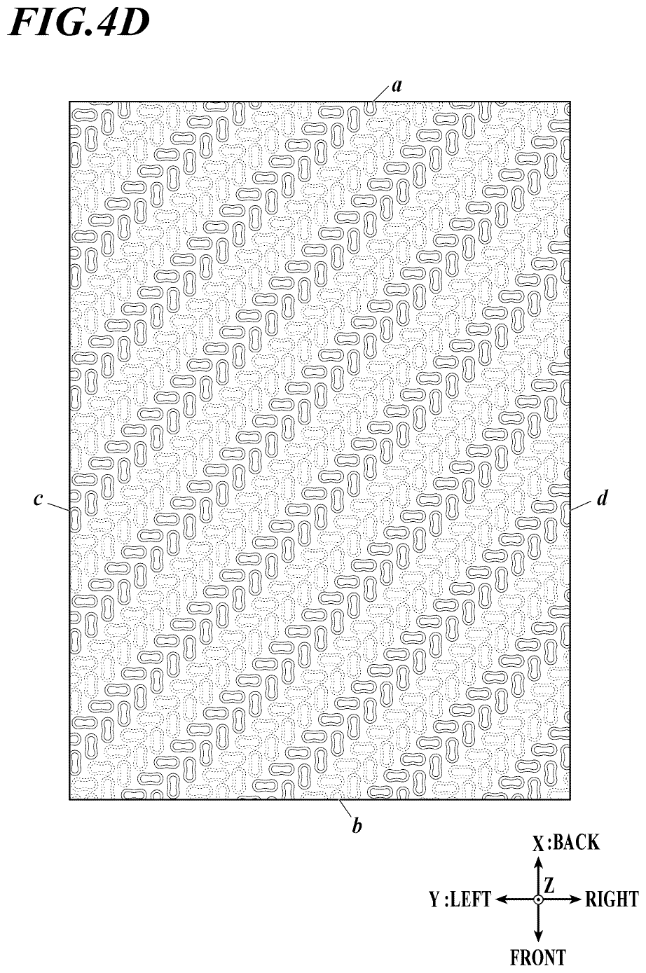

As illustrated in FIG. 4A, the non-embossment part 40 was provided at a proportion of 37.5% with respect to the area of the base paper sheet.

The other respects were the same as those in Example 2-1.

### c Example 2-3: Non-Embossment Part 50%)

As illustrated in FIG. 4B, the non-embossment part 40 was provided at a proportion of 50.0% with respect to the area of the base paper sheet.

The other respects were the same as those in Example 2-1.

### d Comparative Example 2-1: Non-Embossment Part 0%, Serial Arrangement

As illustrated in FIG. 4C, gourd-shaped convex embossments and concave embossments with long axis directions parallel to the first direction were alternately arranged over the entire surface of the base paper sheet, thereby creating a test sheet with no non-embossment part 40. The other respects were the same as those in Example 2-1.

### e Comparative Example 2-2: Non-Embossment Part 0%, Zigzag Shape

A plurality of first convex embossments and second convex embossments, which were gourd-shaped embossments, with different long axis directions were provided. The first convex embossments that were adjacent in the short axis direction were arranged to overlap parts of both the first convex embossments in the short axis direction and to be deviated in the long axis direction. The second convex embossments that were adjacent in the short axis direction were arranged to overlap parts of both the second convex embossments in the short axis direction and to be deviated in the long axis direction.

Such a plurality of first convex embossments and second convex embossments were caused to be adjacent to each other with the long axis directions forming a substantially right angle and were continuously arranged from the first side a of the base paper sheet to the second side b opposite to the first side a.

Also, the concave embossments were arranged in an embossment pattern similar to that of the convex embossments alternately with the convex embossments, thereby creating a test sheet with no non-embossment part 40 as illustrated in FIG. 4D.

The other respects were the same as those in Example 2-1.

### f Comparative Example 2-3: Non-Embossment Part 100%

A test sheet having only the non-embossment part 40 was created without performing embossing working. The other respects were the same as those in Example 2-1.

### [(2) Test Contents]

The cleaning wet wipes in Examples 2-1 to 2-3 and Comparative Examples 2-1 to 2-3 were attached to the cleaning tools having flat rectangular heads of 250 mm×100 mm, thereby creating the cleaning wet sheet wipers in Examples 2-1 to 2-3 and Comparative Examples 2-1 to 2-3. The cleaning wet sheet wipers were used to conduct the following tests 1 to 3.

[a Test 1: Wiping streak test]
(i) The wet sheet wiper with a weight placed thereon such that the total weight was 400 g was placed on a right end (one end in the long side direction of the blackboard, located on the right side as seen by the tester) of a black board with the head facing it. The blackboard used was a wooden wall-hanging blackboard (450 mm×300 mm in size) manufactured by Umajirushi Co., Ltd.)
(ii) The weight and the wet sheet wiper were pushed from the right end to the left end (the other end opposite the above one end in the long side direction of the blackboard, located on the left side as seen by the tester) of the black board and were moved by 300 mm.
(iii) Generated wiping streaks were visually evaluated by taking a state where substantially no wiping streaks occurred on the cleaning surface (the wet area was about 90% to 100% with respect to the entire cleaning surface) as a circle, a state where wiping streaks slightly occurred (the wet area was about 80% to 90% with respect to the entire cleaning surface) as a triangle, and a state where many wiping streaks occurred (the wet area was not more than 80% with respect to the entire cleaning surface) as a cross mark.

### [b Test 2: Wiping-Off Performance Test]

(i) Pseudo-stain obtained by blending beef tallow:olive oil:chloroform:fluorescent paint at a ratio of 12.5:12.5:74.4:0.6 (mass ratio) was dropped in amount of 15 ml and was spread on a stainless steel plate of 480 mm×320 mm and was then dried by a hot air drier (temperature of 60° C.) for 5 minutes, and the weight of the stainless steel plate was measured.
(ii) The wet sheet wiper with a weight placed thereon such that the total weight was 500 g was placed on the right end (one end in the long side direction of the stainless steel plate, located on the right side as seen by the tester) of the stainless steel plate with the head facing it.
(iii) The weight and the wet sheet wiper were pushed and moved from the right end to the left end (the other end opposite the above one end in the long side direction of the stainless steel plate, located on the left side as seen by the tester) of the stainless steel plate, only the stainless steel plate was dried again by the hot air drier (temperature of 60° C.) for 5 minutes, and the weight was measured.
(iv) The wiping amount of each cleaning wet wipe was calculated from a difference between the weight of the stainless steel plate before the test measured in (i) and the weight of the stainless steel plate after the test measured in (iii).
(v) The operations in (i) to (iv) were performed twice, and an average value of the wiping amounts was calculated.
   [c Test 3: Wiping resistance test]
(i) The wet sheet wiper with a weight placed thereon such that the total weight was 500 g was placed on a composite flooring such that the head faced it. The composite flooring used was Home Floor (part number: HF-100N) manufactured by DIY Century Co., Ltd.

(ii) A hole was opened at a head connecting part of the wiper body, and a push-pull gauge (DS2-200N manufactured by IMADA Co., Ltd.) was attached to the hole.

(iii) The maximum resistance value when the wet sheet wiper with the push-pull gauge attached thereto was pulled by 50 cm was measured.

(iv) The operation in (iii) was performed five times, and an average value of wiping resistances was calculated.

### [(3) Test Results]

Results of the tests 1 to 3 are shown in Table II.

TABLE II

| | COMPARATIVE | COMPARATIVE | | | | |
|---|---|---|---|---|---|---|
| | EXAMPLE 2-1 | EXAMPLE 2-2 | | | | COMPARATIVE |
| | NON- | NON- | EXAMPLE 2-1 | EXAMPLE 2-2 | EXAMPLE 2-3 | EXAMPLE 2-3 |
| | EMBOSSMENT | EMBOSSMENT | NON- | NON - | NON- | NON- |
| | PART 0% | PART 0% | EMBOSSMENT | EMBOSSMENT | EMBOSSMENT | EMBOSSMENT |
| | (SERIES) | (ZIGZAG) | PART 25% | PART 37.5% | PART 50% | PART 100% |
| TEST 1 | X | Δ | ◯ | ◯ | ◯ | ◯ |
| (WIPING | | | | | | |
| STREAK | | | | | | |
| AMOUNT) | | | | | | |
| TEST 2 | 3.30 g | 3.90 g | 4.35 g | 4.12 g | 4.00 g | 3.87 g |
| (WIPING | | | | | | |
| AMOUNT) | | | | | | |
| N = 2 | | | | | | |
| TEST 3 | 2.14N | 2.20N | 2.16N | 2.08N | 2.02N | 2.44N |
| (WIPING | | | | | | |
| RESISTANCE) | | | | | | |
| N = 5 | | | | | | |

### [(4) Evaluation]

It is possible to ascertain from comparison of the results of the test 1 that occurrence of wiping streaks was able to be further reduced in Examples 2-1 to 2-3 in which the non-embossment part 40 was provided as compared with Comparative Example 2-1 and Comparative Example 2-2 in which the non-embossment part 40 was not provided. This is considered to be because the pressure imparted on the convex embossments 21 increased due to the non-embossment part 40 being provided and the chemical agent discharge properties were enhanced.

On the other hand, occurrence of wiping streaks slightly increased as the proportion of the non-embossment part 40 increased, in comparison of Examples 2-1 to 2-3 and Comparative Example 2-3. This is considered to be because as the proportion of the non-embossment part 40 increased, the number of convex embossments 21 correspondingly decreased, the contact area with the black board decreased, and the chemical agent discharge properties decreased.

Also, it is possible to ascertain from comparison of the results of the test 2 that the wiping amount increased and wiping-off performance was thus improved in Examples 2-1 to 2-3 in which the non-embossment part 40 was provided as compared with Comparative Example 2-1 and Comparative Example 2-2 in which the non-embossment part 40 was not provided.

On the other hand, it is possible to ascertain from comparison of Examples 2-1 to 2-3 that it was possible to wipe-off the largest amount of dirt in Example 2-1 in which the non-embossment part 40 was provided at the proportion of 25% and the dirt wiping amount decreased as the non-embossment part 40 increased. This is considered to be because as the proportion of the non-embossment part 40 increased, the number of convex embossments 21 correspondingly decreased, and the chemical agent discharge properties and the dirt scraping properties decreased as described above.

Also, in comparison of the results of the test 3, the wiping resistance was high only in Comparative Example 3-3 in which the embossments 20 were not provided in the entire surface, while there was no significant difference in wiping resistances in Comparative Example 2-1 and Comparative Example 2-2 in which the non-embossment part 40 was not provided and in Examples 2-1 to 2-3 in which the non-embossment part 40 was provided.

This is considered to be because the wiping resistance over the entire cleaning wet wipe 100 was not very different since the non-embossment part 40 was unlikely to be grounded with the surface to be cleaned.

### INDUSTRIAL APPLICABILITY

The present invention can be suitably used in the field of manufacturing cleaning wet wipes.

### REFERENCE SIGNS LIST

100 Cleaning wet wipe
20 Embossment
21 Convex embossment
22 Concave embossment
30 Embossment block
31 Embossment block row
40 Non-embossment part
200 Cleaning tool
201 Head
a First side
b Second side
C Third side
d Fourth side

1. A cleaning wet wipe that is obtained by impregnating a base paper sheet with a chemical agent, wherein
the chemical agent has a hydrogen ion exponent of 8.0 to 9.0 and contains 0.05% by mass to 0.15% by mass of polyoxyethylene alkyl ether and 5.00% by mass to 15.00% by mass of ethanol.

2. The cleaning wet wipe according to claim 1, wherein the chemical agent contains 8.00% by mass to 12.00% by mass of ethanol.

3. The cleaning wet wipe according to claim 1, comprising:
embossment blocks in each of which a plurality of convex embossments that are embossments having convexity in a first surface of the cleaning wet wipe are gathered, wherein the embossment blocks which are a plurality of embossment blocks are continuously arranged and form embossment block rows from a first side to a second side opposite to the first side; and
a non-embossment part where the embossments are not arranged, between other ones of the embossment blocks which are adjacent, wherein
the embossment block rows which are a plurality of embossment block rows are continuously arranged from a third side perpendicularly intersecting the first side to a fourth side opposite to the third side,
the non-embossment part is provided at a proportion of not less than 25% and not more than 50% with respect to an area of the cleaning wet wipe, and
the convex embossments are arranged such that at least one of the convex embossments is present on a straight line extended perpendicularly from an arbitrary point on the third side to the fourth side.

4. The cleaning wet wipe according to claim 3, comprising concave embossments that are embossments having convexity in a second surface of the cleaning wet wipe, wherein
the embossment blocks are combinations of the plurality of convex embossments and the concave embossments, and
the concave embossments are arranged such that at least one of the concave embossments is present on a line extended from an arbitrary point on the third side to the fourth side.

5. The cleaning wet wipe according to claim 3, wherein
an angle formed between a long axis direction of the embossments and a first direction that perpendicularly intersects the first side is not less than 5° and not more than 45°, and
the embossment blocks have diamond shapes.

6. The cleaning wet wipe according to claim 3, wherein the embossments have oval shapes and have narrowed parts at substantially centers thereof in a long axis direction.
